(19) United States
(12) Patent Application Publication
(10) Pub. No.: US 2020/0184430 A1
(43) Pub. Date: Jun. 11, 2020

(54) ELECTRONIC TICKET MANAGEMENT SYSTEM, ELECTRONIC TICKET MANAGEMENT METHOD AND ELECTRONIC TICKET MANAGEMENT PROGRAM

(71) Applicant: Mallservice Inc., Yokohama-shi, Kanagawa (JP)

(72) Inventor: Yasuhiro UMEMOTO, Kyoto (JP)

(21) Appl. No.: 16/302,405

(22) PCT Filed: Aug. 1, 2018
(86) PCT No.: PCT/JP2018/028888

§ 371 Date: Nov. 16, 2018

(51) Int. Cl. G06Q 20/04; G06Q 20/32; G06Q 30/06; H04L 9/32; H04L 9/08; G06Q 10/02

(52) U.S. Cl. CPC G06Q 20/0457; G06Q 20/325; G06Q 30/0637; H04L 2209/38; H04L 9/3247; H04L 9/0866; G06Q 10/02; H04L 9/3242

(57) ABSTRACT

To implement an electronic ticket management system having tamper-resistance and promptness.

An electronic ticket management system includes a user terminal, and a node group, in which the user terminal includes a terminal registration means which generates a terminal signature based on user terminal information and adds the generated terminal signature to a block on a main-chain, and a transaction application means which generates an owner signature and adds the generated owner signature to the block on the main-chain, the node group has a transaction approval means which generates an administrator signature and adds the generated administrator signature to the block on the main-chain, and generates a transaction approver signature and adds the generated transaction approver signature to a block on a sub-chain, the main-chain has a block including a hash value based on the terminal signature, the owner signature, the administrator signature, and the block on the sub-chain, and the sub-chain has a block including a hash value based on the transaction approver signature and transaction attribute information.

### TECHNICAL FIELD

The present invention relates to an electronic ticket management system, an electronic ticket management method, and an electronic ticket management program.

### BACKGROUND ART

In recent years, attempts have been made to manage an admission ticket for an event site on an electronic device. In a ticket management by paper media, it is difficult to take measures to prevent resale, and ticket prices soar, so that a ticket management system that manages ownership on tickets and prevents resale is required.

Patent Literature 1 discloses a technology related to an electronic ticket selling device including a sale request receiving unit that receives a sale request for selling an electronic ticket including at least information for specifying an event to be participated from a first purchaser who has purchased the electronic ticket, an invalidation unit that transmits information for restricting a use of the electronic ticket to an authentication device for authenticating the electronic ticket after receiving the sale request, a selling unit that presents the electronic ticket to a second purchaser who purchases the electronic ticket after receiving the sale request and transmits information on the electronic ticket to the second purchaser when the electronic ticket is sold, and a validation unit that transmits information for enabling the use of the electronic ticket to the authentication device for authenticating the electronic ticket after the electronic ticket is sold.

### CITATION LIST

### Patent Literature

Patent Literature 1: JP 2018-26078 A

### SUMMARY OF INVENTION

### Technical Problem

However, when processing on an electronic ticket management including a ticket transfer, an admission into an event site and a settlement in the event site is performed by a management server group, there is a risk that various types of information on the processing are falsified by a malicious user.

The tamper-resistance of the electronic ticket management system can be improved by introducing a hash chain as a block chain.

However, when an approval operation on a block chain related to a ticket transaction is performed based on a consensus formation by a public node group, there is a risk that the ticket transfer or the admission cannot be performed smoothly, because promptness of the approval operation related to the transaction is unable to be kept.

The present invention has been made in view of the above circumstances, and an object of the present invention is to implement an electronic ticket management system having tamper-resistance and promptness.

### Solution to Problem

To solve the above problem, an electronic ticket management system according to the present invention includes a user terminal and a node group,

in which the user terminal includes a terminal registration means which generates a terminal signature based on user terminal information and adds the generated terminal signature to a block on a main-chain, and

a transaction application means which generates an owner signature and adds the generated owner signature to the block on the main-chain,

the node group has a transaction approval means which generates a administrator signature and adds the generated administrator signature to the block on the main-chain and generates a transaction approver signature and adds the generated transaction approver signature to a block on a sub-chain,

the main-chain has a block including a hash value based on the terminal signature, the owner signature, the administrator signature, and the block on the sub-chain, and

the sub-chain has a block including a hash value based on the transaction approver signature and transaction attribute information.

With such a configuration, the electronic ticket management can be performed based on a plurality of private chains having tamper-resistance and promptness. The main-chain according to the present invention is provided for managing the ownership of the electronic ticket or the deposit processing for the deposit and the like. Further, the sub-chain according to the present invention is provided for admission processing into the event site associated with the electronic ticket or management related to settlement processing in the event site.

According to a preferred embodiment of the present invention, the transaction approval means adds the administrator signature to the block on the main-chain, generates the hash value based on the block, and adds the block including the hash value to the main-chain.

With such a configuration, it is possible to record a history related to an electronic commerce including the ticket transfer in the form of the hash chain.

According to a preferred embodiment of the present invention, the transaction application means generates the hash value based on the block to which the transaction approver signature is added and adds the block including the hash value to the sub-chain.

With such a configuration, it is possible to record the history related to the electronic commerce including the ticket admission or the settlement processing in the event site in the form of the hash chain. In addition, since the generation of the block of the sub-chain is performed by the user terminal 2, the sub-chain is persisted to the user terminal 2.

According to a preferred embodiment of the present invention, the transaction approval means generates electronic ticket identification information based on a hash value generated by using at least one of event information, date information, and seat information regarding an electronic ticket, and associates information regarding the main-chain and the sub-chain with the electronic ticket identification information.

With such a configuration, it is possible to associate the information included in the block on the main-chain and the sub-chain according to the present invention with the electronic ticket.

According to a preferred embodiment of the present invention, the transaction approval means generates the administrator signature based on a result of verifying a signature by decryption processing on the terminal signature and/or a result of verifying a signature by decryption processing on the owner signature.

With such a configuration, the transaction approval processing on the main-chain according to the present invention can be performed based on the result of the verification processing on the user terminal and the owner of the ticket

According to a preferred embodiment of the present invention, the transaction approval means generates the transaction approver signature based on a result of verifying a signature by decryption processing on the terminal signature and/or a result of verifying a signature by decryption processing on the administrator signature.

With such a configuration, the transaction approval processing on the sub-chain according to the present invention can be performed based on the result of the verification processing on the user terminal and the owner of the ticket

According to a preferred embodiment of the present invention, the main-chain has a block including a hash value based on the terminal signature, the owner signature, the administrator signature, the block on the sub-chain, user attribute information, and a user public key, and

the terminal registration means adds the user attribute information including at least one of a user face image, user personal information, and user bio-information to the block on the main-chain.

With such a configuration, the information that is provided for performing the verification processing on the user terminal or the ticket owner when the transaction approval means generates the administrator signature can be recorded on the main-chain.

According to a preferred embodiment of the present invention, the transaction approval means generates the transaction approver signature based on a position authentication processing with respect to a user who has performed an intention input regarding transaction application processing and/or identity authentication processing.

With such a configuration, the verification processing on the thicket owner performed when the transaction approval means generates the transaction approver signature and adds the generated transaction approver signature to the sub-chain can be performed based on the position authentication processing and/or the identity authentication processing.

According to a preferred embodiment of the present invention, the position authentication processing is performed based on a signal receiving history regarding the user terminal.

With such a configuration, the position authentication processing can be performed based on various signals received by the user terminal in indoor positioning or outdoor positioning.

According to a preferred embodiment of the present invention, the signal receiving history indicates information transmitted and received by wireless communication via the node group or information on signal strength regarding the wireless communication.

With such a configuration, the position authentication processing can be performed based on the information or the signal strength for various signals received by the user terminal in the indoor positioning or the outdoor positioning.

According to a preferred embodiment of the present invention, the wireless communication uses at least one of a radio wave, an ultrasonic wave, and a visible light wave.

With such a configuration, the wireless communication in the indoor positioning or the outdoor positioning can be realized by the combinations of radio waves, ultrasonic waves, and visible light waves, and the electronic ticket management system according to the present invention can be realized regardless of radio wave interruption property of the event site.

According to a preferred embodiment of the present invention, the identity authentication processing is performed based on similarity detection processing between a user face image captured by the node group and a user face image added to the main-chain.

With such a configuration, it is possible to generate the transaction approver signature by the transaction approval means and add the transaction approver signature to the sub-chain after performing the identity authentication processing by the face authentication.

According to a preferred embodiment of the present invention, the transaction application means suppresses, as a turning point of an output of a user private key, reception of an intention input regarding a transaction application processing, generation of an electronic signature regarding the main-chain and the sub-chain, and generation of the hash value regarding the main-chain and the sub-chain.

With such a configuration, it is possible to inhibit an admission by unauthorized tickets based on key leakage by suppressing the update processing related to the sub-chain.

According to a preferred embodiment of the present invention, when the block on the main-chain includes the owner signature and does not include the administrator signature, the transaction application means suppresses generation of an electronic signature regarding the sub-chain and generation of the hash value.

With such a configuration, it is possible to inhibit the update processing of the sub-chain including the admission into the event site or the like using the electronic ticket when the transfer of the electronic ticket is not completed.

According to a preferred embodiment of the present invention, the transaction attribute information indicates an entrance/exit history by a user who has performed the intention input regarding transaction application processing or a settlement history by the user in an event site associated with an electronic ticket.

With such a configuration, it is possible to manage the admission into the event site or the settlement processing in the event site by the update processing of the sub-chain associated with the electronic ticket.

According to a preferred embodiment of the present invention, the node group includes at least one main node at which generation of the administrator signature is performed and

at least one sub-node at which generation of the transaction approver signature is performed, the at least one main node is disposed on a public network, and

the at least one sub-node is disposed on a private network.

With such a configuration, it is possible to perform the processing on the electronic ticket management via the private network when the event site associated with the electronic thicket has a difficulty in connecting to the public network for the reason that it has the radio wave interruption property or the like.

According to a preferred embodiment of the present invention, the at least one main node and the at least one sub-node are connected to each other on the private network, and

the private network is a mesh network.

With such a configuration, it is possible to perform the processing on the electronic ticket management via the private network when the event site associated with the electronic thicket has a difficulty in connecting to the public network for the reason that it has the radio wave interruption property or the like.

According to the present invention, an electronic ticket management method includes:

a terminal registration step of generating a terminal signature based on user terminal information and adding the generated terminal signature to a block on a main-chain;

a transaction application step of generating an owner signature and adding the generated owner signature to the block on the main-chain; and

a transaction approval step of generating an administrator signature and adding the generated administrator signature to the block on the main-chain, and generating a transaction approver signature and adding the generated transaction approver signature to a block on a sub-chain,

in which the main-chain has a block including a hash value based on the terminal signature, the owner signature, the administrator signature, and the block on the sub-chain, and

the sub-chain has a block including a hash value based on the transaction approver signature and transaction attribute information.

According to the present invention, an electronic ticket management program causes a computer to function as:

a terminal registration means which generates a terminal signature based on user terminal information and adds the generated terminal signature to a block on a main-chain;

a transaction application means which generates an owner signature and adds the generated owner signature to the block on the main-chain; and

a transaction approval means which generates a administrator signature and adds the generated administrator signature to the block on the main-chain, and generates a transaction approver signature and adds the generated transaction approver signature to a block on a sub-chain,

in which the main-chain has a block including a hash value based on the terminal signature, the owner signature, the administrator signature, and the block on the sub-chain, and

the sub-chain has a block including a hash value based on the transaction approver signature and transaction attribute information.

### Advantageous Effects of Invention

According to the present invention, the electronic ticket management system having the tamper-resistance and the promptness can be realized based on the private chain.

### BRIEF DESCRIPTION OF DRAWINGS

FIG. 1 is a schematic diagram of an electronic ticket management system according to a first embodiment of the present invention.

FIG. 2 is a functional block diagram and a hardware configuration diagram in the first embodiment of the present invention.

FIG. 3 is a processing flowchart of a ticket transfer process and a ticket admission process according to the first embodiment of the present invention, and a schematic diagram showing information included in a main-chain and a sub-chain.

FIG. 4 is a schematic diagram showing an outline of a chain update in the main-chain or the sub-chain according to the first embodiment of the present invention.

FIG. 5 is a schematic diagram showing a processing flowchart of a terminal signature and terminal registration and a processing flowchart of an owner signature and a transferee signature according to the first embodiment of the present invention.

FIG. 6 is a schematic diagram showing an outline of user verification processing based on an existence verification protocol according to the first embodiment of the present invention.

FIG. 7 is a functional block diagram and a hardware configuration diagram in a second embodiment of the present invention.

FIG. 8 is a processing flowchart of a settlement guarantee process according to a third embodiment of the present invention, and a schematic diagram showing information included in a main-chain and a sub-chain.

### DESCRIPTION OF EMBODIMENTS

### First Embodiment

An electronic ticket management system 1 according to a first embodiment of the present invention will be described below with reference to the drawings. The following embodiment is an example of the present invention, and the present invention is not limited to the following embodiments, and can adopt various configurations.

For example, in the first embodiment, a configuration, an operation, and the like of the electronic ticket management system 1 will be described, but a method having a similar configuration, a server device, a computer program, a recording medium and the like can also obtain the same operation and effect.

In addition, the program may be stored in the recording medium. By using this recording medium, for example, the program can be installed in a computer. Here, the recording medium in which the program is stored may be a non-transitory recording medium such as a CD-ROM.

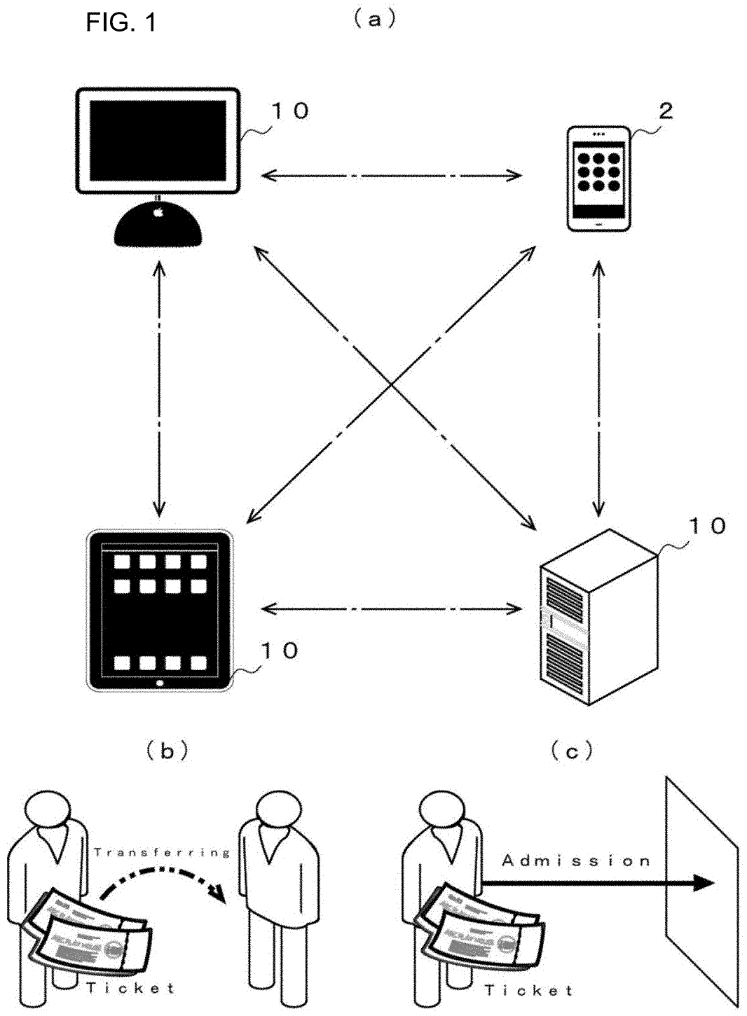

In the first embodiment, the information on the electronic ticket is managed in a form of a distributed database using a plurality of computer devices 10 as a node group and one or more user terminals 2 (FIG. 1(a)), processing on a ticket transfer (FIG. 1(b)), and processing on a ticket admission (FIG. 1(c)) are performed. The ticket transfer refers to a transfer of a ticket ownership.

In the first embodiment, the node group includes one or more main nodes 3 and one or more sub-nodes 4. At this time, the node group may include the computer device 10 which does not include the function included in the main node 3 or the function included in the sub-node 4.

In the first embodiment, an intention input by a user is performed using applications stored in a user terminal 2. The intention input by the user related to the electronic ticket management is not limited thereto, and may use a method for transmitting an e-mail to a user's mail address or other various methods such as SMS.

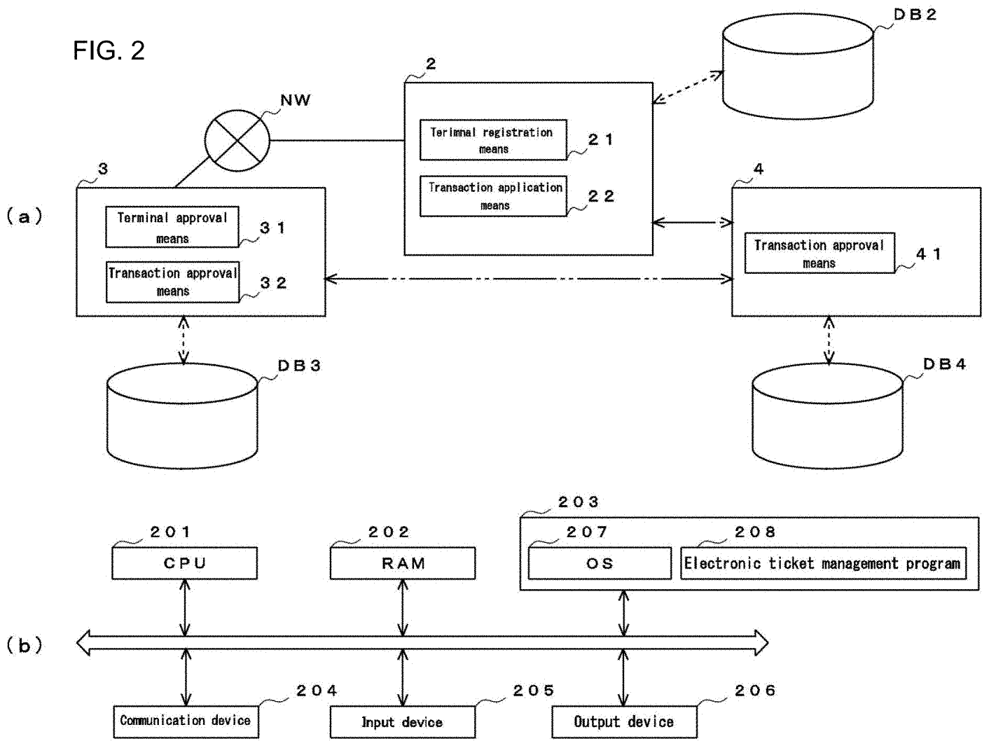

FIG. 2 shows a functional block diagram and a part of a hardware configuration diagram of the electronic ticket management system 1 according to the embodiment of the present invention.

As shown in FIG. 2(a), the electronic ticket management system 1 includes the user terminal 2, the main node 3, and the sub-node 4.

The user terminal 2 and the main node 3 can perform data communication via a public network NW1 using, for example, transmission control protocol/Internet protocol (TCP/IP) or the like as a communication protocol. In addition, the public network NW1 is based on various lines such as a community antenna television (CATV) line and a mobile communication network.

It is preferable that the user terminal 2, the main node 3, and the sub-node 4 can perform mutual communication via the private network NW2. At this time, the private network NW2 has a network configuration based on short-range communication systems such as a wireless local area network (wireless LAN), Bluetooth (registered trademark), and Zigbee (registered trademark). In addition, the private network NW2 may be a form of a mesh network based on pear to pear (P2P) communication.

FIG.2(b) is a diagram showing an example of a hardware configuration of the user terminal 2. The user terminal 2 includes an arithmetic device (CPU 201), a main storage device (RAM 202), an auxiliary storage device (recording device 203) such as a hard disk drive (HDD), a solid state drive (SSD), and a flash memory, a communication device 204 which is an interface for performing communication via the public network NW1 and/or the private network NW2, an input device 205, and an output device 206.

The recording device 203 stores an operating system 207 and an electronic ticket management program 208 which performs the functions in cooperation with the operating system 207, or the like.

It is preferable that the input device 205 in the first embodiment may be an input device such as a touch panel and the output device 206 may be configured as a display or the like.

In the first embodiment, it is preferable that the main node 3 and the sub-node 4 are configured to include various sensor devices provided for user verification processing based on an existence verification protocol to be described later in addition to a hardware configuration included in the user terminal 2. At this time, the user terminal 2, the main node 3 and the sub-node 4 may be configured as terminals such as smart phones.

The user terminal 2 includes a terminal registration means 21 and a transaction application means 22. The main node 3 includes a terminal approval means 31 and a transaction approval means 32. The sub-node 4 has a transaction approval means 41.

A ticket transfer process including transfer request processing and transfer approval processing in the first embodiment is performed on a main-chain M0.

The main-chain M0 has an electronic signature related to the ticket transfer process and a hash value MH in which the electronic signature, information on a public key, and information on a ticket owner are encrypted. At this time, the hash value MH indicates a hash value MH in which information included in the immediately preceding block in the main-chain M0 is encrypted.

The electronic signature included in a block B0 on the main-chain M0 indicates a terminal signature SGN1 generated based on a user private key K20 and user terminal information UD, an owner signature SGN2 generated based on the user private key K20 and a part of user attribute information UM, a transferee signature SGN3 generated based on a user private key K25 included in the main node 3 and associated with a transferee and the user attribute information UM, and an administrator signature SGN4 generated based on a main node private key K30 included in the main node 3.

The information on a ticket owner included in the block B0 on the main-chain M0 indicates the user public key K21 associated with the user private key K20 included in the user terminal 2, and the user attribute information UM including at least one of a user face image UF, user personal information UP, and user bio-information UB.

In the first embodiment, finality on the main-chain M0 is obtained each time the chain update (step MX) is completed, and a block immediately before an additional block B1 is treated as a definite block.

In the first embodiment, the ticket admission process including admission application processing and admission approval processing is performed on a sub-chain S0.

The sub-chain S0 has an electronic signature related to the ticket admission process and a hash value SH in which the electronic signature and entrance/exit information ETR are encrypted. At this time, the hash value SH indicates a hash value SH obtained by encrypting the immediately preceding block in the sub-chain S0.

The electronic signature included in the block B0 on the sub-chain S0 indicates a transaction approver signature SGN5 generated based on the sub-node private key K40 included in the sub-node 4.

In the first embodiment, the finality on the sub-chain S0 is obtained each time the chain update (step SX) is completed, and the block immediately before the additional block B1 is treated as the definite block.

Next, the functions of the transaction application means 22 and the transaction approval means 32 and 41 in the first embodiment will be described with reference to the processing flowchart of the ticket transfer process and the ticket admission process.

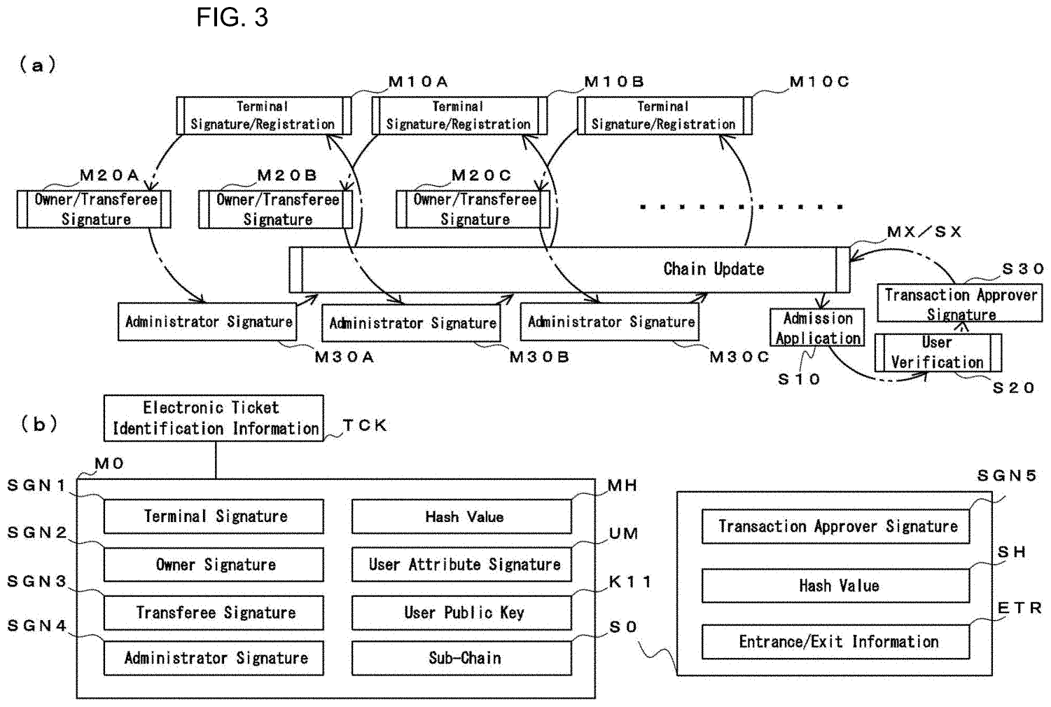

FIG. 3 shows the processing flowchart (FIG.3(a)) of the ticket transfer process and the ticket admission process and a schematic diagram (FIG. 3(b)) of the main-chain M0 and the sub-chain S0.

First, the processing flowchart on the main-chain M0 related to the ticket transfer process will be described. In the first embodiment, the main-chain M0 is associated with each ticket, and the main-chain M0 is updated each time the ticket is transferred.

In the ticket transfer process, upon the ticket transfer and after the chain update (step MX), the terminal signature SGN1 is added to the block generated by the terminal registration means 21, and the terminal approval processing is performed by the terminal approval means 31 (step M10).

Next, the addition of the owner signature SGN2 by the transaction application means 22 and addition of the transferee signature SGN3 by the transaction approval means 32 are performed (step M20).

Next, the administrator signature SGN4 is added by the transaction approval means 32 (step M30).

Finally, the generated block (block B0) on the main-chain M0 is encrypted and the hash value MH is generated (step MX). A series of procedures are repeated each time the electronic ticket is transferred, and for example, the processing (step M20) on the terminal signature in FIG. 3(a) is denoted by steps M20A and M20B.

As shown in FIG. 3(b), the main-chain M0 includes the above-described plurality of electronic signatures, the hash value included in the immediately preceding block, the user public key K21, the user attribute information UM, and the sub-chain S0. At this time, the main-chain M0 is associated with electronic ticket identification information TCK.

The electronic ticket identification information TCK is individually allocated to the electronic ticket in order to prevent ticket duplication on the electronic ticket management system 1. The electronic ticket identification information TCK includes a hash value generated by unidirectional conversion based on at least one of unique information on the event site, a start time, a seat and the like associated with the electronic ticket.

In the first embodiment, it is preferable that in a state of a distributed Key-Value Store (distributed KVS), the information on the main-chain M0 and the block B0 on the sub-chain S0 and the electronic ticket identification information TCK are stored in the databases DB2, DB3, and DB4. At this time, the Key related to the main-chain M0 in the distributed KVS becomes the electronic ticket identification information TCK.

In the first embodiment, it is preferable that the information on the main-chain M0 stored in the database DB2 and the block B0 on the sub-chain S0 is information on the electronic ticket associated with the user terminal 2 having the database DB2.

Next, each step related to the ticket transfer process described in FIG. 3(a) will be described in detail.

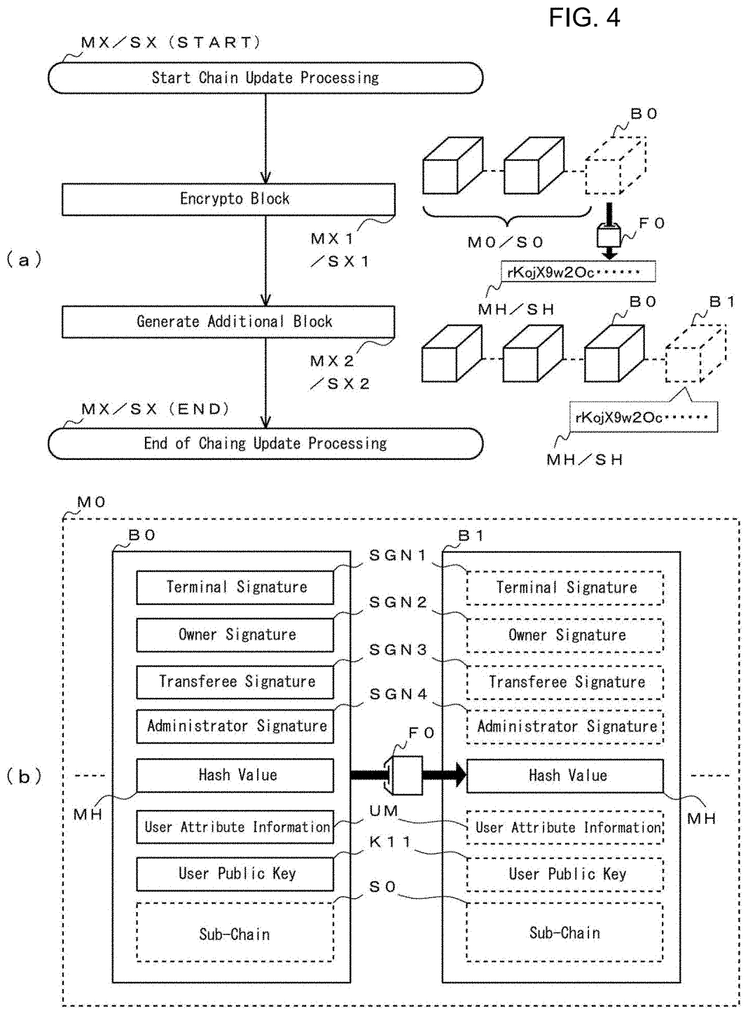

FIG. 4 shows a processing flowchart (FIG. 4(a)) of the update (step MX) of the main-chain M0, the update (step SX) of the sub-chain S0 described later, and a schematic diagram (FIG. 4(b)) of the signature information or the like which is included in the block on the main-chain M0.

As shown in FIG. 4(a), the chain update (step MX) is performed by a series of processing procedures of the encryption (step MX1) of the block B0 on the main-chain M0 and the generation (step MX2) of the definite/additional block B1 of the block B0.

The transaction approval means 32 encrypts the block B0 on the main-chain M0 based on a one-way function F0 to generate the hash value MH (step MX1).

It is preferable that the unidirectional conversion performed at the time of generating the hash value is configured to be performed by an encryption method such as an RSA method, a DSA method, and a Schnorr method. The encryption processing may be configured to be performed by the unidirectional conversions plural times or may be configured to add a random number or metadata at the time of performing the unidirectional conversion.

After the generation of the hash value MH (step MX1), the transaction approval means 32 performs the generation of the additional block B1 (step MX2). The hash value MH is added to the additional block B1, and the processing on the chain update (step MX) is completed.

As shown in FIG. 4(b), the hash value MH in the chain update (step MX) is generated by encrypting the terminal signature SGN1, the owner signature SGN2, the transferee signature SGN3, the administrator signature SGN4, the hash value MH related to the immediately preceding block, the user attribute information UM, the user public key K21, and the block B0 on the sub-chain S0, in the block B0 on the main-chain M0. At this time, the block B0 on the sub-chain S0 at least includes the hash value SH in which the block on the sub-chain S0 is encrypted and the entrance/exit information ETR.

Based on the one-way function F0, the hash value MH obtained by encrypting the information on the block B0 as described above is added to the additional block B1. At this time, it is preferable that the information on the sub-chain S0 is also added to the additional block B1.

It is to be noted that the transaction approval means 32 generates a genesis block in the main-chain M0. The hash value MH obtained by encrypting the administrator signature SGN4 is at least added to the genesis block.

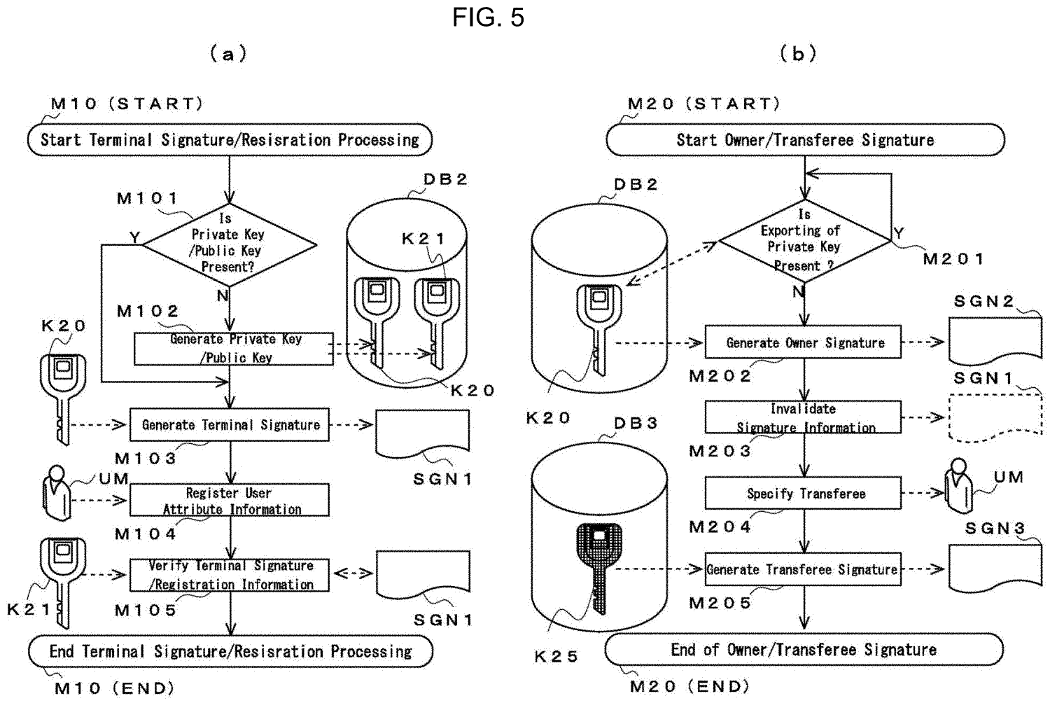

FIG. 5(a) shows a processing flowchart of the terminal registration/signature (step M10).

In the user terminal 2, when the user private key K20 and the user public key K21 cannot be referenced (No (N) in step M101), the terminal registration means 21 generates the user private key K20 and the user public key K21 (step M102). At this time, it is preferable that the generation related to the user private key K20 is based on a random number, a character string input by a user operation, or the like. It is preferable that the generation related to the user public key K21 is performed based on the user private key K20. The encryption generation is similar to the step MX, and the type of encryption method is not particularly limited.

When the user private key K20 and the user public key K21 can be referenced (Yes (Y) in step M101), the user private key K20 and the user public key K21 are not generated.

After the processing (steps M101 and M102) on the user private key K20 and the user public key K21, the terminal registration means 21 generates the terminal signature SGN1 (step M103).

In generation of the terminal signature SGN1, at least the user terminal information UD is unidirectionally converted using the user private key K20. It is preferable that the user terminal information UD is information such as a terminal identifier UDID for identifying the user terminal 2 or an application identifier UAID individually allocated to the electronic ticket management program 208.

After the generation/addition of the terminal signature SGN1, the user transmits the user attribute information UM including at least one of the user personal information UP including the identification information ID, the user face image UF, and the user bio-information UB to the node group including the main node 3 and the sub-node 4 (step M104). The transmitted user attribute information UM is sequentially stored.

After the transmission of the user attribute information UM (step M104), the terminal registration means 21 adds, to the block B0 on the main-chain M0, reference information such as links related to the user personal information UP and the user face image UF. At this time, it is preferable that the reference information is stored as a Value in the distributed KVS.

The terminal approval means 31 performs the signature verification for the added terminal signature SGN1 and the user attribute information UM (step M105). In the verification, the terminal signature SGN1 is decrypted using the user public key K21, and the validity of the user terminal information UD is verified. In addition, in the verification, the validity of the user's identification information ID is verified. When the validity is confirmed by the verification, the check of the validity of the user terminal 2 is notified. The notification may be performed via the distributed KVS.

In the first embodiment, the terminal approval means 31 may be configured to generate the administrator signature SGN4, when the validity of the terminal signature SGN1 and the user terminal 2 is confirmed, by the decryption processing associated with the terminal signature SGN1.

The terminal registration means 21 adds the user public key K21 to the block B0 on the main-chain M0 and completes the terminal signature/registration (step M10), when the validity of the terminal signature SGN1 and the user attribute information UM is notified.

FIG. 5(b) shows the processing flowchart of the addition of the owner signature SGN2 and the transferee signature SGN3 to the block B0 on the main-chain M0 (step M20).

The ticket transfer process is started based on the intention input by the user. The transaction application means 22 first performs a determination regarding the writing of the user private key K20 included in the user terminal 2 (step M201). When the writing of the user private key K20 is performed (Yes (Y) in step M201), the process proceeds to the state just before step M201, and the reception of all intention input related to the ticket transfer process is inhibited.

If the writing of the user private key K20 is not performed (No (N) in step M201), the process proceeds to the following step, and the processing on the ticket transfer is performed on another user terminal 2 held by the user or another user (hereinafter, referred to as a transferee) from the user terminal 2 of the user (hereinafter, referred to as a transferor) holding the ticket.

The transaction application means 22 generates the owner signature SGN2 based on the user private key K20 (step M202). At this time, it is preferable that the owner signature SGN2 is configured so that the transaction contents including information on the transferee who is a ticket transfer destination are encrypted.

After the generation of the owner signature SGN2 (step M202), the transaction application means 22 performs invalidation processing on the electronic signature including the terminal signature SGN1 in the block B0 on the main-chain (step M203). It is preferable that the invalidation processing is performed by the update of the distributed KVS, and the invalidation processing is notified to the node group via the distributed KVS when being performed. The invalidation of the terminal signature SGN1 by the invalidation processing is provided for inhibiting the admission approval processing related to the ticket admission process to be described later.

When the notification related to the owner signature SGN2 is performed, the transaction approval means 32 performs the identification of the transferee related to the ticket transfer (step M204). It is preferable that the identification is performed based on the transaction contents obtained by the decryption processing of the owner signature SGN2. At this time, the transaction contents may include information indicating a settlement history related to the ticket transfer.

The transaction approval means 32 performs the generation/addition of the transferee signature SGN3, when the notification related to the invalidation processing of the electronic signature including the terminal signature SGN1 in the block B0 on the main-chain M0 is performed (step M205). At this time, the transferee signature SGN3 is generated by the node group based on the user private key K25 of the main node 3. The user private key K25 is individually generated according to the user terminal 2 associated with the transferor and the transferee in the electronic ticket management system 1.

In the first embodiment, the user private key K20 and the user public key K21 are generated in advance in the user terminal 2 associated with the transferee, and the transferee signature SGN3 may be generated based on the user private key K20 using the intention input by the transferee as the turning point upon the ticket transfer process. At this time, it is preferable that the user private key K20 is generated in the terminal signature/registration (step M10) related to the user terminal 2 included in the transferee.

Finally, the information on the generation/addition of the transferee signature SGN3 is applied to the distributed KVS, and the notification related to the transferee signature SGN3 is performed to complete the processing (step M20) on the owner signature SGN2 and the transferee signature SGN3.

The transaction approval means 32 performs the generation of the administrator signature SGN4 and the addition of the administrator signature SGN4 to the block B0 on the main-chain M0 at least based on the terminal signature SGN1, the owner signature SGN2, and the transferee signature SGN3 (step M30). The administrator signature SGN4 is generated based on the main node private key K30.

The transaction approval means 32 performs the verification for the electronic signature by the decryption processing using the user public key K21 and performs the approval operation. In order to ensure the promptness of the electronic ticket management system, it is preferable that the verification and approval are performed by one or more specific nodes only.

The approval on the administrator signature SGN4 is performed based on continuity of the hash value on the main-chain M0. The continuity in the first embodiment indicates consistency between the result of decrypting the hash value in neighboring blocks and the signature or the like included in the block, and the like.

When there is an unauthorized hash value having no continuity or an unauthorized electronic signature having no validity on the main-chain M0, the transaction approval means 32 does not perform the approval on the main-chain M0. At this time, the transaction approval means 41 that generates/adds the transaction approver signature SGN5 related to the ticket admission process to be described later does not perform the approval on the sub-chain S0. As a result, the transaction including the transfer/admission related to the electronic ticket associated with the main-chain M0/sub-chain S0 and the reception of the intention input related to the transaction are inhibited.

Next, the processing flowchart on the sub-chain S0 related to the ticket admission process will be described. In the first embodiment, the sub-chain S0 is individually associated with the electronic ticket, and the chain update (step SX) including the addition of the block on the sub-chain S0 is performed each time the ticket admission is performed.

As shown in FIG. 3(a), in the ticket admission process based on the sub-chain S0, first, the admission application by the transaction application means 22 is performed using the intention input by the user operation as the turning point (step S10).

Next, the verification processing is performed on the user who has performed the admission application based on the existence verification protocol (step S20). In the user verification processing, an identity authentication process A10 and a position authentication process A20 for the user are performed.

The transaction approval means 41 generates the transaction approver signature SGN5 based on the result of the user verification processing based on the existence verification protocol and adds the generated transaction approver signature SGN5 to the block B0 on the sub-chain S0 (step S30). Finally, the chain update (step SX) of the sub-chain S0 is performed, such that the ticket admission process is completed.

As shown in FIG. 4(a), in the chain update (step SX) of the sub-chain S0, a series of processing of the encryption (step SX1) of the block B0 on the sub-chain S0 and the generation (step SX2) of the definite/additional block B1 of the block B0 are performed by the transaction application means 22.

The transaction approval means 22 encrypts the block B0 on the sub-chain S0 based on a one-way function F0 to generate the hash value SH (step SX1).

After the generation of the hash value SH (step SX1), the transaction approval means 22 performs the generation of the additional block B1 (step SX2). The hash value SH is added to the additional block B1, and the chain update (step SX) is completed.

The hash value SH is generated by encrypting the transaction approver signature SGN5, the hash value SH related to the immediately preceding block, and entrance/exit information ETR in the block B0 on the sub-chain S0.

Next, each step related to the ticket admission process described in FIG. 2(a) will be described in detail.

When the user private key K20 is not written, the transaction application means 22 receives the intention input by the user related to the admission application and starts the admission application (step S10). The admission application may be notified to the node group via the distributed KVS.

The transaction application means 22 instructs the user to present the contents indicating the identification information ID, when the intention input is received by the user related to the admission application. At this time, the sub-node 4 may be configured to read the contents via a face authentication camera CAM.

In the first embodiment, the intention input by the user related to the admission application is performed via the input device 205. At this time, the intention input may be performed when a micro electro mechanical system (MEMS) device including a gyro sensor detects an external force such as vibration.

In addition, a two-dimensional code may be displayed on the user terminal 2 as a display processing of intention by the user related to the admission application. At this time, the intention input related to the admission application may be performed when the two-dimensional code is scanned by the node group.

The transaction approval means 41 performs the validity verification for the terminal signature SGN1 related to the electronic ticket associated with the admission application by the reference to the distributed KVS and the decryption processing based on the user public key K21, when the notification related to the admission application is performed.

In the ticket admission process, when the admission application is performed, the process does not proceed to the following steps in the case in which the terminal signature SGN1 is invalidated.

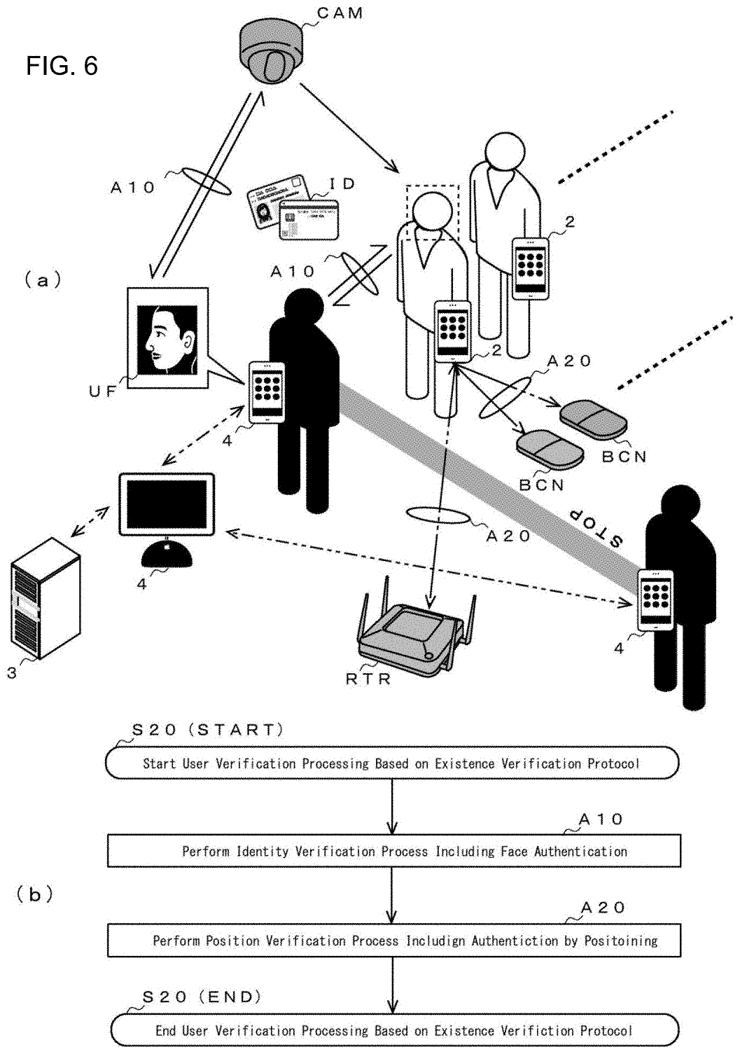

Next, in the ticket admission process, the user verification processing (step S20) based on the existence verification protocol will be described with reference to FIG. 6.

FIG. 6 shows a schematic diagram (FIG. 6(a)) and a processing flowchart (FIG. 6(b)) related to the user verification processing based on the existence verification protocol in the first embodiment.

As shown in FIG. 6(b), the user verification processing based on the existence verification protocol in the first embodiment includes the identity authentication process A10 including the face authentication and the position authentication process A20 including the authentication by the positioning.

The positioning according to the position authentication process A20 in the first embodiment is performed based on the signal reception history included in the user terminal 2.

In the first embodiment, the main node 3 and the sub-node 4 may include the positioning device and/or the face authentication device, which are provided for the user verification processing based on the existence verification protocol, in a hardware configuration.

It is preferable that the user verification processing is performed based on the Bluetooth (registered trademark) communication including Bluetooth Low Energy (registered trademark), which is included in a smart phone, a tablet, or the like, or an imaging result by an image sensor or the like.

As shown in FIG. 6(a), the positioning according to the position authentication process A20 is performed by one or more one-way communication beacon BCN and/or one or more two-way communication router RTR. In addition, the identity verification is performed based on the user face image captured by the face authentication camera CAM.

In the identity authentication process A10, similarity detection between the user face image captured by the face authentication camera CAM and the user face image UF included in the user attribute information UM in the block B0 on the main-chain M0 is performed by streaming processing using an image processing library such as DLIB mounted on the sub-node 4.

In the identity authentication process A10, the transaction approval means 41 further checks the presented user's identification information ID, the user personal information UP included in the user attribute information UM on the block B0 in the main-chain M0 to perform the validity verification for the identification information ID.

In the presentation of the contents indicating the identification information ID, the identification information ID is read by a machine learning library, and the hash value based on the written contents and the hash value based on the user personal information UP are checked to perform the identity verification according to the identity authentication process A10.

The identity verification according to the identity authentication process A10 may be performed based on bio-information including at least one of a fingerprint, a voice print, an iris and a vein pattern. At this time, the sensor device provided for sensing the bio-information is installed in a state in which it is connected to the main node 3 or the sub-node 4 via the network.

In the position authentication process A20, the user terminal 2 acquires position information based on an received signal strength indicator (RSSI) value and/or a universally unique identifier (UUID) related to a short-distance wireless signal received from one or more one-way communication beacons BCN installed in the event site.

The transaction application means 22 generates the hash value by encrypting the position information based on the signal received via the one-way communication beacon BCN and transmits the generated hash value to the node group. At this time, the hash value may be included in the entrance/exit information ETR in the sub-chain S0. The transaction approval means 41 verifies the validity of the position information based on the hash value.

In addition, in the position authentication process A20, the user terminal 2 acquires the position information via the two-way communication router RTR. At this time, the medium through which the two-way communication router RTR is provided for information transmission includes not only radio waves including a millimeter wave band but also ultrasonic waves, visible light waves and the like.

In consideration of the diversity of the event contents carried out at the event site, it is preferable that the medium provided for the wireless communication for positioning is also diverse, and the type of communication mediums installed at the event site and combinations thereof are no limitation.

In the first embodiment, the position authentication process A20 may be performed by global positioning system (GPS) positioning by satellite communication.

The transaction application means 22 generates the hash value based on the position information obtained via the two-way communication router RTR and transmits the generated hash value to the node group. At this time, the hash value may be included in the entrance/exit information ETR in the sub-chain S0. The transaction approval means 41 verifies the validity of the position information based on the hash value.

The information acquired by the one-way communication beacon BCN and two-way communication router RTR provided for positioning related to the user verification processing based on the existence verification protocol and the face authentication camera CAM provided for face authentication is transmitted via the private network NW2 or the public network NW1 in the event site associated with the electronic ticket.

When the identity authentication process A10 and the position authentication process A20 related to the user verification processing based on the existence verification protocol are performed, it is preferable to update the distributed KVS or the like via the private network NW2 in the case in which the sensor device group, the user terminal 2 and the sub-node 4 are not connected to the public network NW1.

In the first embodiment, the position information on the position authentication process A20 may include information on a movement path obtained based on a signal receiving history included in the user terminal 2.

Next, the generation/addition (step S30) of the transaction approver signature SGN5 in the ticket admission process will be described.

The transaction approval means 41 generates the transaction approver signature SGN5 using the sub-node private key K40 based on the result of the user verification processing (step S20) based on the existence verification protocol.

When the transaction approver signature SGN5 is generated, the transaction approval means 41 at least determines the location of the user and adds the transaction approver signature SGN5 to the block B0 on the sub-chain S0, based on the position information of the user terminal 2 and/or the similarity detection result related to the face image which are obtained by the user verification processing based on the existence verification protocol.

In the first embodiment, the authentication of the ticket owner by the verification process based on the existence verification protocol may be performed by assigning a weight to various types of information obtained during the verification process. For example, when parameters related to reliability are assigned to various types of weighted information and when the sum of the parameters exceeds a predetermined threshold, the result by the verification is positive, that is, the location of the ticket owner at the event site is recognized.

When the transaction approval means 41 adds the transaction approver signature SGN5 to the block B0 on the sub-chain S0, the transaction application means 22 performs the update processing (step SX) including the generation/addition of the block in the sub-chain S0. By notifying the sub-node 4 of the updating processing through the distributed KVS, the ticket admission process is completed and the information on the admission permission to the user is determined. At this time, in accordance with the determination, it may be configured to manage the admission into the event site by the user in a mode of electronic tearing.

In the chain update (step SX) on the sub-chain S0, the transaction application means 22 performs the update of the entrance/exit information ETR. In addition, in the distributed KVS, the entrance/exit information ETR on the block B0 on the sub-chain S0 is stored as a Key, and various types of information on the user verification processing based on the electronic signature or the existence verification protocol in the block B0 on the sub-chain S0 is stored as a Value. As a result, in the sub-chain S0, the simultaneous generation of blocks including a block branch is inhibited.

In the first embodiment, the ticket transfer process or the ticket admission process may be configured to associate one user indicating information on a plurality of visitors with one electronic ticket. At this time, in the ticket admission process, the admission permission is individually determined for the plurality of visitors.

When one user indicating the information on the plurality of visitors is associated with one electronic ticket, the face authentication according to the identity authentication process A10 is performed by capturing a face image of a specific visitor among the plurality of visitors and performing the similarity detection to the user face image UF. At this time, during the terminal registration/authentication (step M10), the user face image UF related to a specific visitor is registered.

In the first embodiment, the exporting of the user private key K20 is displayed or printed in the form of a two-dimensional code or a character code when the intention input related to exporting is performed.

When the user private key K20 is exported, the user private key K20 is input to different user terminals 2, the generation/addition (step M10) related to the terminal signature SGN1 is performed again, and the terminal authentication by the terminal approval means 31 is completed, such that the transfer/admission related to the electronic ticket associated with the immediately previous user private key K20 exported becomes possible. Therefore, when the identity information is not registered through the registration of the user attribute information UM, the approval processing based on the electronic signature using the user private key K20 in the first embodiment is not completed.

The update processing related to the sub-chain S0 in the first embodiment may be performed when the user exits the event site.

### Second Embodiment

An electronic ticket management system 1 according to a second embodiment of the present invention will be described below. It is to be noted that the same reference numerals are given to the same components as those of the first embodiment, and a description thereof will be omitted.

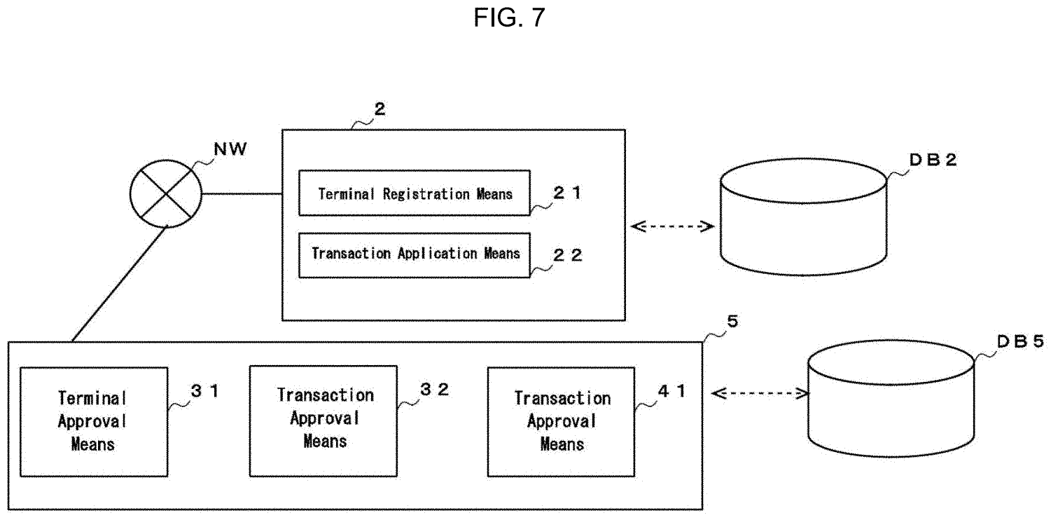

As shown in FIG. 7, in the second embodiment, a node group 5 has functions related to a main node 3 and a sub-node 4. In addition, a database DB5 has various types of information included in the databases DB3 and DB4 in the first embodiment.

It is preferable that the node group 5 is preferably connected to a public network NW1, includes generation/addition of a block on a main-chain M0 and a sub-chain S0, and reflects update processing immediately. At this time, a sensor device group related to user verification processing based on an existence verification protocol may be included in a hardware configuration of the node group 5.

### Third Embodiment

An electronic ticket management system 1 according to a third embodiment of the present invention will be described below. It is to be noted that the same reference numerals are given to the same components as those of the first or second embodiment, and a description thereof will be omitted.

A main-chain M0 and a sub-chain S0 in the third embodiment are provided for a settlement guarantee process. In the present invention, the settlement guarantee process indicates a series of processing such as processing of depositing a deposit amount according to a ticket admission, recording a transaction history related to a small amount settlement in an event site, and performing settlement processing based on the transaction history when a user exits from an event site. The small amount settlement in the third embodiment refers to settlement in which a payment amount does not exceed a deposit amount.

It is preferable that the deposit of the deposit amount in the settlement guarantee process is performed based on an electronic commerce using various legal tenders or cryptocurrencies. At this time, the type of currencies used for the electronic commerce transaction is not particularly limited.

In the third embodiment, it is preferable that the main-chain M0 is updated each time deposit processing is performed.

In the settlement guarantee process according to the third embodiment, to perform the approval related to the deposit processing of the deposit amount, the generation of the electronic signature or the like is performed on the main-chain M0, and to manage the transaction history related to the small amount settlement performed in the event site associated with the electronic ticket, the generation or the like of the electronic signature is performed on the sub-chain S0.

A hardware configuration diagram and a functional block diagram of the electronic ticket management system 1 according to the third embodiment have the same configuration as that of the first or second embodiment.

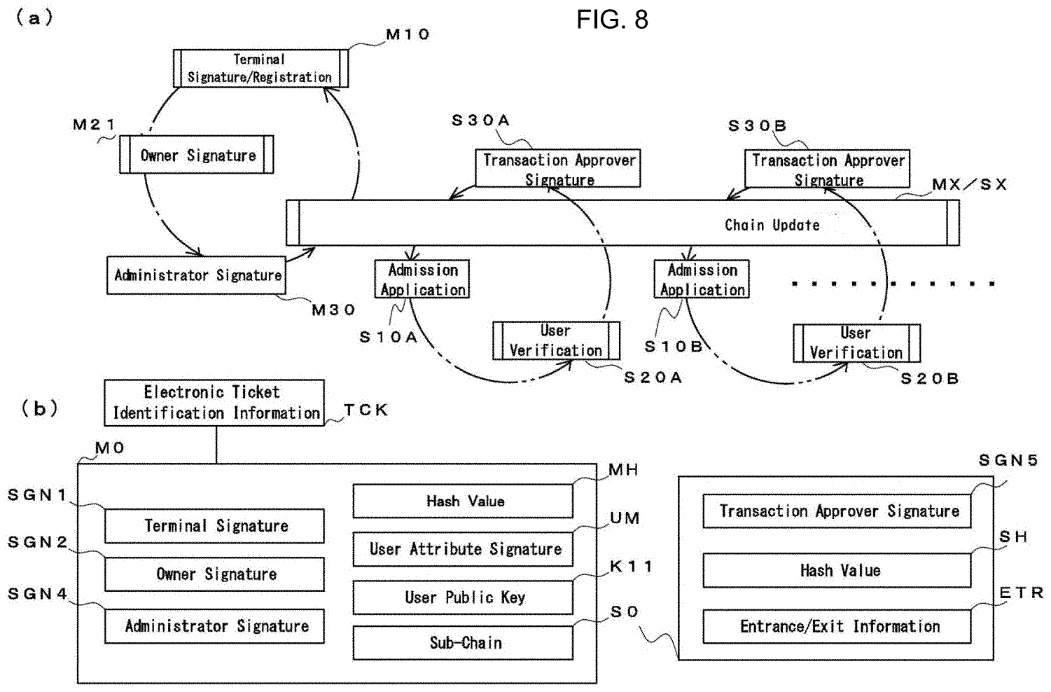

FIG. 8 shows a process flowchart of the settlement guarantee process according to the third embodiment, and various types of information included in the main-chain M0 and the sub-chain S0.

As shown in FIG. 8(a), a chain update (step MX) in the third embodiment is performed by a terminal signature/registration (step M10) by a terminal registration means 21, generation/addition (step M21) of an owner signature by a transaction application means 22, and generation/addition (step M30) of an administrator signature by a transaction approval means 32.

It is preferable that the chain update (step MX) in the third embodiment is performed through the same processing procedure as the chain update (step MX) in the first or second embodiment. However, various types of information included in the block B0 on the main-chain M0 is based on the configuration shown in FIG. 8.

The generation/addition of the owner signature in the third embodiment (step M21) indicates a series of processing, in which a processing procedure related to a transferee signature SGN3 is excluded, among the processing procedures included in the generation/addition (step M20) of the owner signature/transferee signature in the first or second embodiment. However, it is preferable that at the time of generating an owner signature SGN2, the transaction contents to be encrypted are the information indicating the electronic commerce history related to the deposit described above.

In the generation/addition of the administrator signature in the third embodiment (step M30), it is preferable that when decryption processing related to the owner signature SGN2 is performed, the main node 3 verifies validity of the information on the above-mentioned electronic commerce history included in the owner signature SGN2 and generates an administrator signature SGN4. At this time, the electronic signature generated by the terminal owned by a customer related to the electronic commerce history may be included in the block B0 on the main-chain M0.

In the third embodiment, it is preferable that the sub-chain S0 be updated each time the small amount settlement is performed by a user in the event site.

In the third embodiment, it is preferable that the chain update (step SX) on the sub-chain S0 is performed by a settlement application (step S10) by the transaction application means 22, user verification processing (step S20) by the transaction approval means 41, and generation/addition of a transaction approver signature SGN5 by the transaction approval means 41. At this time, the chain update (step SX) is performed by the transaction application means 22.

In the third embodiment, it is preferable that the user operation related to the settlement application is configured to have the same procedure as the user operation related to the admission application in the first or second embodiment. At this time, the transaction application means 22 may display the information related to the settlement application in the form of a two-dimensional code or the like.

In the third embodiment, the block B0 on the main-chain M0 has the terminal signature SGN1, the owner signature SGN2, the administrator signature SGN4, user attribute information UM, a user public key K11, a hash value MH in which the block on the main-chain M0 is encrypted, and the block B0 on the sub-chain S0.

The block B0 on the sub-chain S0 according to the third embodiment includes the transaction approver signature SGN5 generated based on a sub-node private key K40, deposit information DPT, and a hash value SH in which the block on the sub-chain S0 is encrypted. The deposit information DPT indicates information on a deposit balance calculated based on the transaction history related to the small amount settlement.

The user verification processing (step S20) according to the third embodiment is performed based on the existence verification protocol. In the third embodiment, in order to easily manage the small amount settlement performed in the event site, the user verification processing may be performed based on at least a part of various types of information verified in identity authentication process A10 and position authentication process A20.

When the generation/addition (step S30) of the transaction approver signature SGN5 is performed by the transaction approval means 41, it is preferable that it is performed by the terminal signature SGN1 of the block B0 on the main-chain M0, the deposit information included in the block B0 on the sub-chain S0, and the settlement history obtained by performing the decryption processing on the hash value SH.

In the third embodiment, the transaction approval means 32 and 41 each verify the continuity of the hash values MH and SH included in the block B0 on the main-chain M0 or the sub-chain S0, respectively, and perform the processing related to the generation/addition of the electronic signature.

In the third embodiment, the transaction approval means 32 inhibits the update processing related to the main-chain M0 and the sub-chain S0, when the user exits the event site. At this time, the transaction approval means 32 may generate the administrator signature based on the information indicating the inhibition and the main node private key K30.

In the third embodiment, the information related to the block B0 on the sub-chain S0 provided for approval related to the small amount settlement and storing of the transaction history related to the small amount settlement may be included in the block B0 on the sub-chain S0 in the first or second embodiment. At this time, it is preferable that the block B0 on the main-chain M0 has various types of information related to the ticket transfer process and various kinds of information indicating the electronic commerce history related to the deposit amount. In addition, the information on the sub-chain S0 provided for the small amount payment management and the information on the sub-chain S0 provided for entrance/exit management may be included in the block on the main-chain M0.

According to the present invention, the electronic ticket management system having the tamper-resistance and the promptness can be realized based on a plurality of private chains and a sensor fusion.

According to the present invention, it is possible to manage the ticket admission without requiring a large-sized apparatus such as a ticket examining machine.

According to the present invention, it is possible to manage the processing related to the ticket purchase/admission/settlement in event site related to event participation by a user on the private chain having the tamper-resistance and the promptness and contribute to the suitable event management.

### REFERENCE SIGNS LIST

1 Electronic ticket management system
2 User terminal
3 Main node
4 Sub-node
5 Node group
10 Computer device
21 Terminal registration means
22 Transaction application means
31 Terminal approval means
32 Transaction approval means
41 Transaction approval means
NW1 Public network
NW2 Private network
DB2, DB3, DB4, DB5 Database
201 CPU
202 RAM
203 Recording device
204 Communication device
205 Input device
206 Output device
207 Operating system
208 Electronic ticket management program
M0 Main-chain
S0 Sub-chain
SGN1 Terminal signature
SGN2 Owner signature
SGN3 Transferee signature
SGN4 Administrator signature
SGN5 Transaction approver signature
K20, K25 User private key
K21, K26 User public key
UD User terminal information
UDID Terminal identifier
UAID Application identifier
UM User attribute information
UP User personal information
UF User face image
UB User bio-information
K30 Main node private key
K31 Main node public key
K40 Sub-node private key
K41 Sub-node public key
MH, SH Hash value
B0 Block
B1 Additional block
F0 One-way function
TCK Electronic ticket identification information
ETR Entrance/exit information
DPT Deposit information
A10 Identity authentication process
A20 Position authentication process
One-way communication beacon BCN
Two-way communication router RTR
Face authentication camera CAM
Identification information ID

1. An electronic ticket management system, comprising:
a user terminal; and a node group,
wherein the user terminal includes a terminal registration means which generates a terminal signature based on user terminal information and adds the generated terminal signature to a block on a main-chain, and
a transaction application means which generates an owner signature and adds the generated owner signature to the block on the main-chain,
the node group has a transaction approval means which generates an administrator signature and adds the generated administrator signature to the block on the main-chain, and generates a transaction approver signature and adds the generated transaction approver signature to a block on a sub-chain,
the main-chain has a block including a hash value based on the terminal signature, the owner signature, the administrator signature, and the block on the sub-chain, and
the sub-chain has a block including a hash value based on the transaction approver signature and transaction attribute information.

2. The electronic ticket management system according to claim 1, wherein the transaction approval means adds the administrator signature to the block on the main-chain, generates the hash value based on the block, and adds the block including the hash value to the main-chain.

3. The electronic ticket management system according to claim 1, wherein the transaction approval means adds the transaction approver signature to the block on the sub-chain, and
the transaction application means generates the hash value based on the block to which the transaction approver signature is added and adds the block including the hash value to the sub-chain.

4. The electronic ticket management system according to claim 1, wherein the transaction approval means generates electronic ticket identification information based on a hash value generated by using at least one of event information, date information, and seat information regarding an electronic ticket, and associates information regarding the main-chain and the sub-chain with the electronic ticket identification information.

5. The electronic ticket management system according to claim 1, wherein the transaction approval means generates the administrator signature based on a result of verifying a signature by decryption processing on the terminal signature and/or a result of verifying a signature by decryption processing on the owner signature.

6. The electronic ticket management system according to claim 1, wherein the transaction approval means generates the transaction approver signature based on a result of verifying a signature by decryption processing on the terminal signature and/or a result of verifying a signature by decryption processing on the administrator signature.

7. The electronic ticket management system according to claim 1, wherein the main-chain has a block including a hash value based on the terminal signature, the owner signature, the administrator signature, the block on the sub-chain, user attribute information, and a user public key, and
the terminal registration means adds the user attribute information including at least one of a user face image, user personal information, and user bio-information to the block on the main-chain.

8. The electronic ticket management system according to claim 1, wherein the transaction approval means generates the transaction approver signature based on a position authentication processing with respect to a user who has performed an intention input regarding transaction application processing and/or identity authentication processing.

9. The electronic ticket management system according to claim 8, wherein the position authentication processing is performed based on a signal receiving history regarding the user terminal.

10. The electronic ticket management system according to claim 9, wherein the signal receiving history indicates information transmitted and received by wireless communication via the node group or information on signal strength regarding the wireless communication.

11. The electronic ticket management system according to claim 10, wherein the wireless communication uses at least one of a radio wave, an ultrasonic wave, and a visible light wave.

12. The electronic ticket management system according to claim 8, wherein the identity authentication processing is performed based on similarity detection processing between a user face image captured by the node group and a user face image added to the main-chain.

13. The electronic ticket management system according to claim 1, wherein the transaction application means suppresses, as a turning point of an output of a user private key, reception of an intention input regarding a transaction application processing, generation of an electronic signature regarding the main-chain and the sub-chain, and generation of the hash value regarding the main-chain and the sub-chain.

14. The electronic ticket management system according to claim 1, wherein when the block on the main-chain includes the owner signature and does not include the administrator signature, the transaction application means suppresses generation of an electronic signature regarding the sub-chain and generation of the hash value.

15. The electronic ticket management system according to claim 1, wherein the transaction attribute information indicates an entrance/exit history by a user who has performed the intention input regarding transaction application processing or a settlement history by the user in an event site associated with an electronic ticket.

16. The electronic ticket management system according to claim 1, wherein the node group includes at least one main node at which generation of the administrator signature is performed and
at least one sub-node at which generation of the transaction approver signature is performed,
the at least one main node is disposed on a public network, and
the at least one sub-node is disposed on a private network.

17. The electronic ticket management system according to claim 16, wherein the at least one main node and the at least one sub-node are connected to each other on the private network, and
the private network is a mesh network.

18. An electronic ticket management method, comprising:
a terminal registration step of generating a terminal signature based on user terminal information and adding the generated terminal signature to a block on a main-chain;
a transaction application step of generating an owner signature and adding the generated owner signature to the block on the main-chain; and
a transaction approval step of generating an administrator signature and adding the generated administrator signature to the block on the main-chain, and generating a transaction approver signature and adding the generated transaction approver signature to a block on a sub-chain,
wherein the main-chain has a block including a hash value based on the terminal signature, the owner signature, the administrator signature, and the block on the sub-chain, and
the sub-chain has a block including a hash value based on the transaction approver signature and transaction attribute information.

19. A non-transitory computer readable medium having stored thereon an electronic ticket management program that when executed causes a computer to function as:
a terminal registration means which generates a terminal signature based on user terminal information and adds the generated terminal signature to a block on a main-chain;
a transaction application means which generates an owner signature and adds the generated owner signature to the block on the main-chain; and
a transaction approval means which generates an administrator signature and adds the generated administrator signature to the block on the main-chain, and generates a transaction approver signature and adds the generated transaction approver signature to a block on a sub-chain,
wherein the main-chain has a block including a hash value based on the terminal signature, the owner signature, the administrator signature, and the block on the sub-chain, and
the sub-chain has a block including a hash value based on the transaction approver signature and transaction attribute information.
